(19) United States
(12) Patent Application Publication
(10) Pub. No.: US 2014/0063423 A1
(43) Pub. Date: Mar. 6, 2014

(54) Liquid crystal display panel

(71) Applicant: InnoLux Corporation, Miao-Li County (TW)

(72) Inventors: Yu-Wei CHEN, Miao-Li County (TW); Chien-Hung CHEN, Miao-Li County (TW)

(73) Assignee: InnoLux Corporation, Miao-Li County (TW)

(21) Appl. No.: 14/010,833

(22) Filed: Aug. 27, 2013

(30) Foreign Application Priority Data
Sep. 5, 2012 (TW) 101132272

(51) Int. Cl. G02F 1/1335

(52) U.S. Cl. CPC G02F 1/133512
USPC 349/110; 349/139

(57) ABSTRACT

A liquid crystal display panel is disclosed, which comprises: a first substrate; a second substrate opposite to the first substrate; an optically isotropic liquid crystal layer disposed between the first substrate and the second substrate; and a protruding electrode layer composed of a polymer conductive material and disposed on the first substrate. Besides, when a protruding part is composed of a non-conductive organic material, the liquid crystal display panel further comprises: an electrode layer disposed on the protruding electrode layer; and a submicron structure layer, a multilayer film, or a micro-reflection layer is disposed between the protruding electrode layer and the first substrate.

### TECHNICAL FIELD

The present invention relates to a liquid crystal display panel, and more particularly to a liquid crystal display panel comprising a protruding electrode layer composed of a polymer conductive material; and a liquid crystal display panel using a submicron structure layer, a multilayer film, or a micro-reflection layer to improve the light leakage.

### BACKGROUND ART

A liquid crystal display (LCD) is a flat thin display device, which has replaced the traditional cathode ray tube display and become one of the most popular display device in recent years for its thin shape, light weight, and low power consumption. A liquid crystal display has been widely used over small portable terminal devices to large size TVs due to its advantageous characteristics.

Blue phase liquid crystal has a self-aggregated three-dimensional photonic crystal structure, wherein the blue phase appears between the isotropic phase and the cholesteric phase at a temperature ranging from 0.5° C. to 2° C. The blue phase liquid crystal structure is divided into three types: BPI, BPII, and BPIII, which are body-centered cubic lattice, simple cubic lattice, and amorphous with local cubic lattice, respectively. Since the blue phase liquid crystal has the self-aggregated three-dimensional periodic structure, and the size of the lattice period is about several hundred nanometers, the blue phase liquid crystal possesses visible Bragg reflection property. Thus, under the influence of the electric field, the orientation change, lattice deformation, phase conversion, and the birefringence effect of the lattice or molecule of the blue phase liquid crystal can be induced. Compared to the current liquid crystal display, the display using the blue phase liquid crystal mode does not need an alignment film and has very fast switching response time.

To achieve a low operating voltage for the polymer-stabilized blue phase liquid crystal, a protruding electrode layer is used in company with an in-plane switching (IPS) liquid crystal to enhance the penetration depth of the electric field; wherein a typical protruding electrode layer includes an indium tin oxide (ITO) electrode layer, but the ITO is fragile. In addition, the multilayer film structure of the protruding electrode layer has a problem of refractive index mismatch, and an amplitude variation of transverse electric field (TE)/transverse magnetic field (TM) mode causes light leakage of the liquid crystal display.

Therefore, what is needed in the art is to develop a liquid crystal display panel whereby the light leakage phenomenon can be effectively improved.

### DISCLOSURE

An object of the present invention is to provide a liquid crystal display panel, thereby effectively improving the light leakage phenomenon of the liquid crystal display.

To achieve the above object, the present invention provides a liquid crystal display panel, comprising: a first substrate; a second substrate opposite to the first substrate; an optically isotropic liquid crystal layer, such as a blue phase liquid crystal layer, disposed between the first substrate and the second substrate; and a protruding electrode layer composed of a polymer conductive material and disposed on the first substrate.

In the present invention, the type for the polymer conductive material of the protruding electrode layer is not limited, and is preferably organic compounds selected from the group consisting of polyaniline, polypyrrole, polyacetylene, polythiophen, and poly(3,4-ethylenedioxythiophene)/poly(styrenesulfonate) (PEDOT/PSS), and more preferably fluorinated ethylene propylene copolymer, such as perfluoro ethylene propylene copolymer, poly(perfluoro ethylene propylene); or tetrafluoroethylene-perfluoroalkoxy vinyl ether copolymer. Thus, the liquid crystal display panel according to the present invention does not need to coat an ITO electrode layer on the protruding electrode layer, thus reducing a refractive interface of an entering light. In addition, since both of the polymer conductive material and the liquid crystal are organics, the refractive index difference between the conductive polymer material and the liquid crystal is smaller than that between the conductive polymer material and an inorganic substance, such as ITO, wherein the refractive index of the liquid crystal material and the conductive polymer material is typically about 1.4 to 1.6, the refractive index of ITO is about 1.8 to 2.1, the refractive index of the glass is about 1.5. Preferably, the difference in the refractive indexes between the conductive polymer material and the liquid crystal is less than 0.5.

In addition, when a protruding part is composed of a non-conductive organic material, the present invention also provides another liquid crystal display panel comprising: a first substrate; a second substrate opposite to the first substrate; an optically isotropic liquid crystal layer, such as a blue phase liquid crystal layer, disposed between the first substrate and the second substrate; a protruding electrode layer disposed on the first substrate, which comprises a protruding part and an electrode, wherein the electrode layer is disposed on the protruding part; and a light leakage-proof unit disposed between the protruding electrode layer and the first substrate, which is selected from the group consisting of a submicron structure layer, a multilayer film, and a micro-reflection layer.

In the present invention, the light leakage-proof unit is the submicron structure layer comprising a plurality of submicron structures. The cross-sectional shape of the plurality of submicron structures is not limited and may be selected from the group consisting of rectangle, trapezoid, triangle, and polygon. Also, the height of the plurality of submicron structures is not limited, as long as it can realize the purpose of reducing the intensity difference of transverse electric field (TE)/transverse magnetic field (TM) caused by overly high refractive index difference at the interface between protruding part and the electrode layer.

Furthermore, a density of the plurality of submicron structures may preferably be directly proportional to an absolute value of an inclined plane slope of the protruding electrode layer, but it is not limited thereto. In other words, an area having a bigger absolute value of an inclined plane slope of the protruding electrode layer has a narrower space between the plurality of submicron structures, i.e., a denser submicron structures; on the contrary, an area having a smaller absolute value of an inclined plane slope of the protruding electrode layer has a wider space between the plurality of submicron structures, i.e., a more isolated submicron structures. When the inclined plane slope of the protruding electrode layer is nearly horizontal (the absolute value of the inclined plane slope is 0 to 0.15), the submicron structure layer has an opening corresponding to this area of the protruding electrode layer.

Accordingly, when the size of the submicron structures is smaller corresponding to the wavelength of incident light, the refraction of the incident light may be influenced by the refractive indexes and the structures of the two mediums at a recessed area between the submicron structures, thereby generating a form birefringence property.

Considering the periodic property of the submicron structures, when the wavelength of incident light is much greater than the period of the submicron structures (Λ/λ<<1), the phase difference can be calculated by the effective medium theory (EMT); otherwise, when such a condition is not met, rigorous coupled-wave analysis (RCWA) may be used for the calculation. Different duty cycles (F) may affect the phase difference, for example, in the case that the submicron structures has a height d=λ and Λ/λ=0.2, a larger phase difference occurs when the duty cycle is about 0.5, while a phase difference is absent when the duty cycle is 0 or 1.

Therefore, if it is desired to obtain submicron structures having a tapering phase difference in one-dimension, the phase difference required for compensation may be estimated based on the optical simulation to calculate the duty cycle required for a maximum phase difference, and then the duty cycle is increased or decreased gradually toward the desired tapering direction. Since the more inclined the interface (the greater the absolute value of an inclined plane slope), the more serious the light leakage, a higher phase difference compensation mechanism is necessary so as to turn the polarization direction of the light to the absorption axis. Accordingly, an area having a bigger absolute value of an inclined plane slope needs to have a duty cycle with a higher value of the phase difference, otherwise, an area having a smaller absolute value of an inclined plane slope needs to have a duty cycle with a lower value of the phase difference. Furthermore, a higher submicron structure results in a higher phase difference, and those of ordinary skill in the art may adjust the phase difference as desired depending on different duty cycles.

When the protruding electrode layer is composed of a non-conductive organic material, the light leakage-proof unit of the liquid crystal display panel according to the present invention may be a multilayer film. After the oblique incidence of light, a change in transmittance of TE and/or TM wave results in a shift of the polarization direction, thereby causing the light leakage. In this case, the greater the incident angle, the greater the shift angle and the more serious the light leakage. Accordingly, the light path is changed by the multilayer film, to reduce the incident angles and improve the light leakage. Preferably, a light incidence form a high refractive index medium to a low refractive index medium is prevented. In addition, when the inclined plane slope of the protruding electrode layer is nearly horizontal (the absolute value of the inclined plane slope is 0 to 0.15), the light leakage is less serious at this area, and the submicron structure layer has an opening corresponding to this area of the protruding electrode layer.

When the protruding electrode layer is composed of a non-conductive organic material, the light leakage-proof unit of the liquid crystal display panel according to the present invention may be a micro-reflection layer. The micro-reflection layer inhibits the light from passing through the interface of the inclined edge with a greater refractive index difference (an area having a greater absolute value of an inclined plane slope) by total reflection. Accordingly, similar to the submicron structures described above, the period and the geometric shape of the micro-reflection layer may be adjusted from center to peripheral, and the direction of the micro-reflection layer may be identical to or different from that of the protruding electrode layer. Here, when the inclined plane slope of the protruding electrode layer is nearly horizontal (the absolute value of the inclined plane slope is 0 to 0.15), the light leakage is less serious at this area, and the submicron structure layer has an opening corresponding to this area of the protruding electrode layer.

Accordingly, when the light leakage-proof unit is the micro-reflection layer, the liquid crystal display panel of the present invention may further include: a high refractive index layer disposed on the first substrate and opposite to the micro-reflection layer. The reflected light of the micro-reflection layer may be totally reflected again by the high refractive index layer, to recover the light and increase the transmittance.

In the present invention, the material of the electrode layer may be a typical electrode material in the art, such as ITO, indium zinc oxide (IZO), or a transparent conductive thin film material (transparent conductive oxide, TCO), etc. The shape of the electrode layer is not particularly limited, as long as it can allow the formation of a non-uniform field between the first electrode layer and the second electrode layer when a voltage is applied. In addition, the first substrate and the second substrate are preferably each a transparent substrate, and may be a plastic substrate or a glass substrate. Also, since the blue phase liquid crystal appears in a narrow temperature range, the blue phase liquid crystal layer may further comprise a polymer to stabilize the blue phase liquid crystal, so that the temperature range of the presence of the blue phase liquid crystal is increased.

### BRIEF DESCRIPTION OF DRAWINGS

The above and other objects, features and other advantages of the present invention will be more clearly understood from the following detailed description taken in conjunction with the accompanying drawings, in which:

FIG. 1 shows a schematic view of the protruding electrode according to Embodiment 1 of the present invention.

FIG. 2A illustrates a schematic view of the protruding electrode with a submicron structure according to Embodiment 2 of the present invention.

FIG. 2B shows a schematic view of the protruding electrode in pair with a submicron structure with a submicron structure according to Embodiment 3 of the present invention.

FIGS. 2C, 2D are cross-sectional views of the fat removal module according to Embodiment 3 of the present invention.

FIGS. 3(A) to (E) show the submicron structure according to Embodiment 2 of the present invention.

FIG. 4A shows the protruding electrode with multilayer film according to Embodiment 4 of the present invention.

FIG. 4B shows the protruding electrode with multilayer film according to Embodiment 5 of the present invention.

FIG. 5A shows entry of light into a conventional liquid display panel according to Comparative Example 1 of the present invention.

FIG. 5B is a graph demonstrating experimental results for shift angle of the protruding part of Comparative Example 1 of the present invention.

FIG. 6 shows entry of light into a liquid display panel in pair with multilayer according to Embodiment 6 of the present invention.

FIG. 7A shows the protruding electrode in pair with micro reflective layer and layer with high refraction rate according to Embodiment 7 of the present invention.

FIG. 7B shows a cross-sectional view of the unit structure of the micro reflective layer according to Embodiment 7 of the present invention.

### BEST MODE

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention, and those skilled in the art will appreciate that various modifications, additions and substitutions are possible.

### Example 1

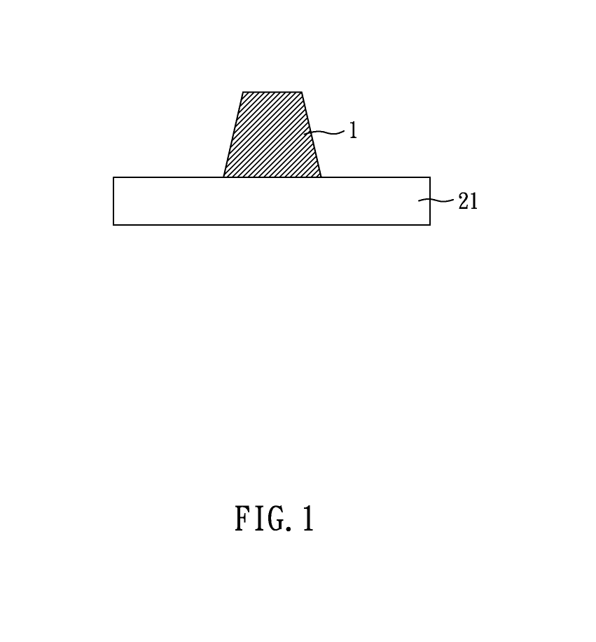

FIG. 1 shows the schematic diagram of the protruding electrode layer according to the present invention. A protruding electrode layer 1 is formed on the glass substrate 21 by using the polymer conductive material, poly(3,4-ethylenedioxythiophene)/poly(styrenesulfonate) (PEDOT/PSS), to reduce the refraction interfaces of the light path, thereby decreasing the light leakage phenomenon. Herein, each of the liquid crystal, glass, and PEDOT/PSS has a refractive index of about 1.4 to 1.6, and thus the difference in the refractive indexes is smaller.

### Example 2

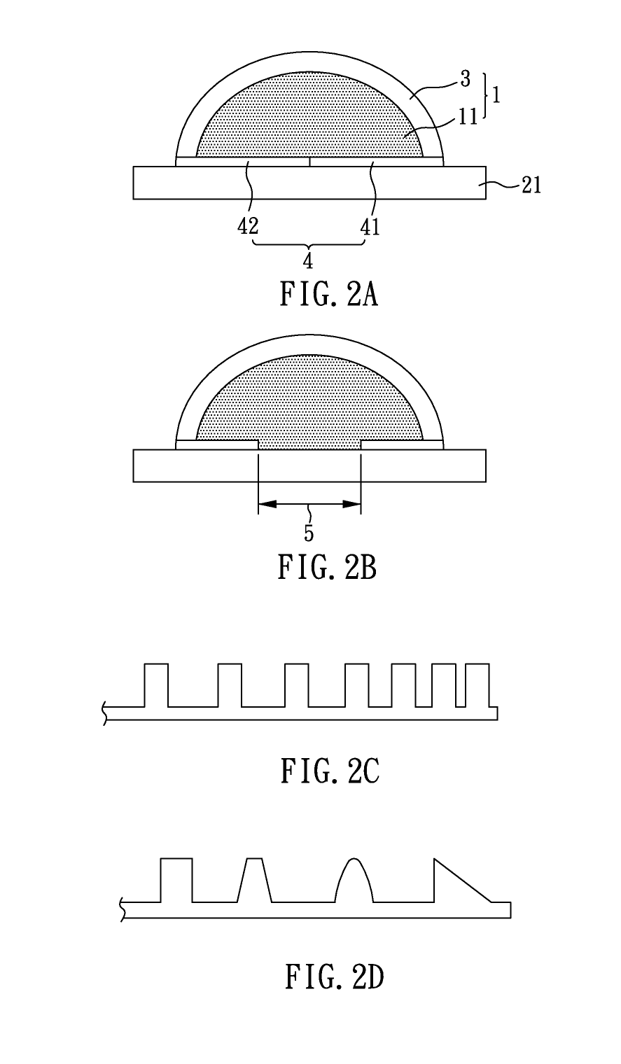

FIG. 2A shows a schematic diagram of the protruding electrode layer with the submicron structures. A protruding part 11 is formed on the glass substrate 21 by using the organic materials, such as fluorinated ethylene propylene copolymer: perfluoro ethylene propylene copolymer, poly(perfluoro ethylene propylene); or tetrafluoroethylene-perfluoroalkoxy vinyl ether copolymer, and then an ITO is coated thereon to serve as an electrode layer 3. In this case, the cross-sectional shape of the protruding electrode layer 1 is semicircular (but the present invention is not limited thereto, the cross-section shape may also be of other shapes such as the semi-elliptical shape). In addition, a submicron structure layer 4 is further disposed between the protruding electrode layer 1 and the glass substrate 21, wherein the submicron structure layer 4 includes the symmetric submicron structure units 41, 42 as shown in FIG. 2C or 2D. Referring to FIG. 2C, the arrangement of the submicron structures that corresponds to the end of protruding electrode layer 1 (more inclined region) is denser; while the arrangement of the submicron structures corresponding to the center of protruding electrode layer 1 (more gentle region) is more isolated. Referring to FIG. 2D, the cross-sectional shape of the submicron structures may be rectangular, trapezoidal, triangular, or so on. The structure of the submicron structure unit 42 can be deduced by the same principle.

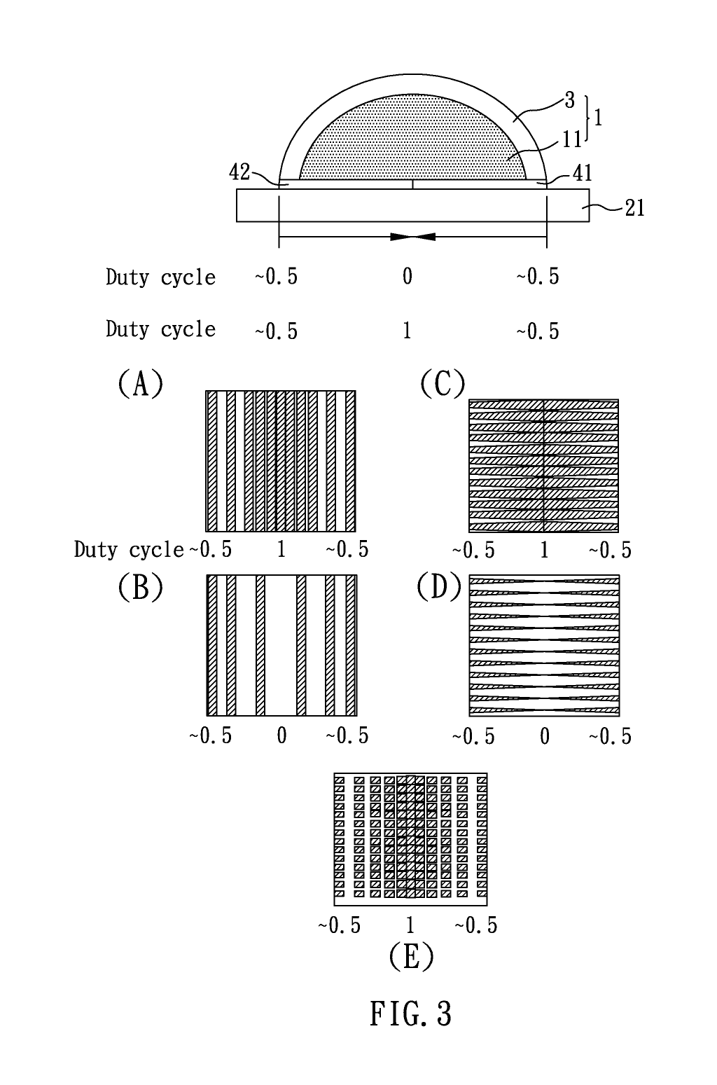

More specifically, the design of the submicron structures is as shown in FIG. 3, wherein the duty cycle corresponding to the end of protruding electrode layer 1 is about 0.5, while the duty cycle corresponding to the center of protruding electrode layer 1 is 0 or 1. Examples of the submicron structures 4 may be illustrated by FIGS. (A) through (E), wherein the submicron structures have the duty cycle Λ=100 nm˜1000 nm, depth of the groove is d=100 nm˜5000 nm, but it is not limited hereto.

### Example 3

FIG. 2B shows a schematic diagram of the protruding electrode layer with the submicron structures. The same manufacturing process as in Example 2 is carried out, except that the middle of the submicron structure units 41, 42 of the submicron structure layer 4 has an opening 5 which corresponds to the center of protruding electrode layer 1 (more gentle region).

### Example 4

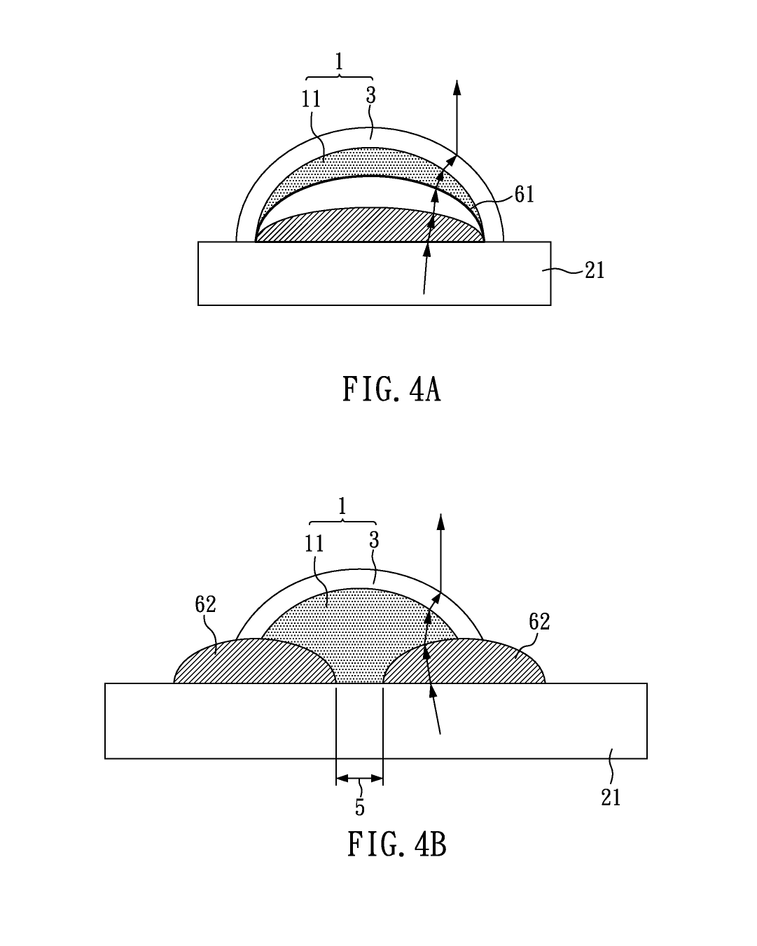

FIG. 4A shows a schematic diagram of the protruding electrode layer with the multilayer film. A protruding part 11 is formed on the glass substrate 21 using the organic materials, such as fluorinated ethylene propylene copolymer: perfluoro ethylene propylene copolymer, poly(perfluoro ethylene propylene); or tetrafluoroethylene-perfluoroalkoxy vinyl ether copolymer, then an ITO is coated thereon to serve as an electrode layer 3; in the current case, the cross-sectional shape of the protruding electrode layer 1 is semicircular (but the present invention is not limited thereto, the cross-sectional shape may also be of other shapes such as the semi-elliptical shape). In addition, a multilayer film 61 is further disposed between the protruding electrode layer 1 and the glass substrate 21. As shown in FIG. 4A, the light path is indicated by the arrowhead, and the light path may be adjusted by its interfaces with different refractive indexes to reduce the incident angle, thereby lowering light leakage phenomenon.

### Example 5

FIG. 4B shows a schematic diagram of the protruding electrode layer with the multilayer film. The same manufacturing process as in Example 4 is carried out, except that the middle of the multilayer films 62 has an opening 5 which corresponds to the center of protruding electrode layer 1 (more gentle region).

### Comparative Example 1

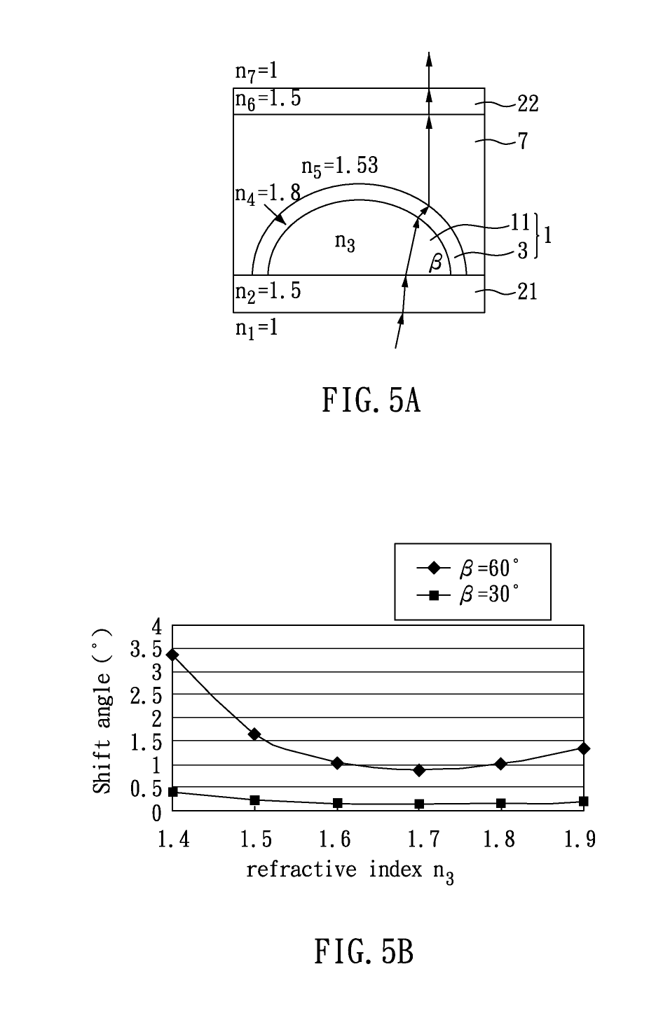

FIG. 5A shows a schematic diagram of a light incidence into a conventional liquid crystal display panel. As illustrated by the arrowhead in FIG. 5A, n represents the refractive index: the light from the air (n₁=1) entering, in sequence, the glass substrate 21 (n₂=1.5), the protruding part 11 (n₃), the ITO electrode layer 3 (n₄=1.8), the blue phase liquid crystal layer 7 (n₅=1.53), and the glass substrate 22 (n₆=1.5), and finally exiting into the air (n₇=1). Herein, the slope angle of the protruding part 11 is β.

As shown in FIG. 5B, when β was 30°, the refractive index of the protruding part 11 was n₃=1.4 to 1.9, and the shift angles were between 0° to 0.5°; when β was 60°, the shift angles were between 0.5° to 3.5°, showing a significant difference, and the higher shift angle caused a more serious light leakage.

### Example 6

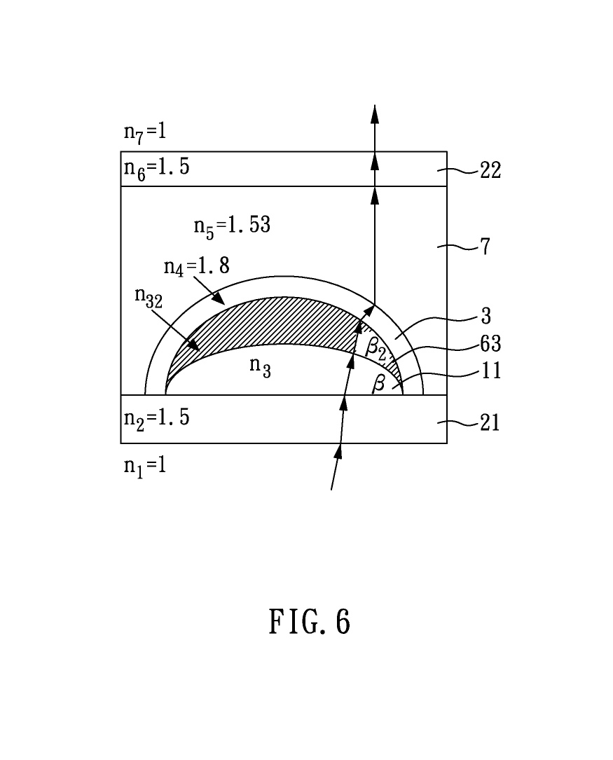

FIG. 6 shows a schematic diagram of a light incidence into the liquid crystal display panel with the multilayer film. As illustrated by the arrowhead in FIG. 6, n represents the refractive index: the light from the air (n₁=1) entering in sequence, the glass substrate 21 (n₂=1.5), the protruding part 11 (n₃), the multilayer film 63 (n₃₂), the ITO electrode layer 3 (n₄=1.8), the blue phase liquid crystal layer 7 (n₅=1.53), and the glass substrate 22 (n₆=1.5), and finally exiting into the air (n₇=1). Herein, the slope angle of the protruding part 11 is β, and the slope angle of the multilayer film 63 is β₂.

TABLE 1

| | | | | | shift angle |
|---|---|---|---|---|---|
| | n₃ | n₃₂ | β(°) | β₂ (°) | (°) |
| protruding part | 1.5 | | 60 | | 1.648227 |
| multilayer film | 1.73 | | 60 | | 0.891809 |
| protruding part + multilayer film | 1.5 | 1.73 | 22 | 38 | 0.816728 |

As shown in Table 1, in the case where both of the protruding part and the multilayer film were used, the shift angle was reduced from 1.648227° (where the protruding part was used only) to 0.816728°, and thus the light leakage can be reduced efficiently.

### Example 7

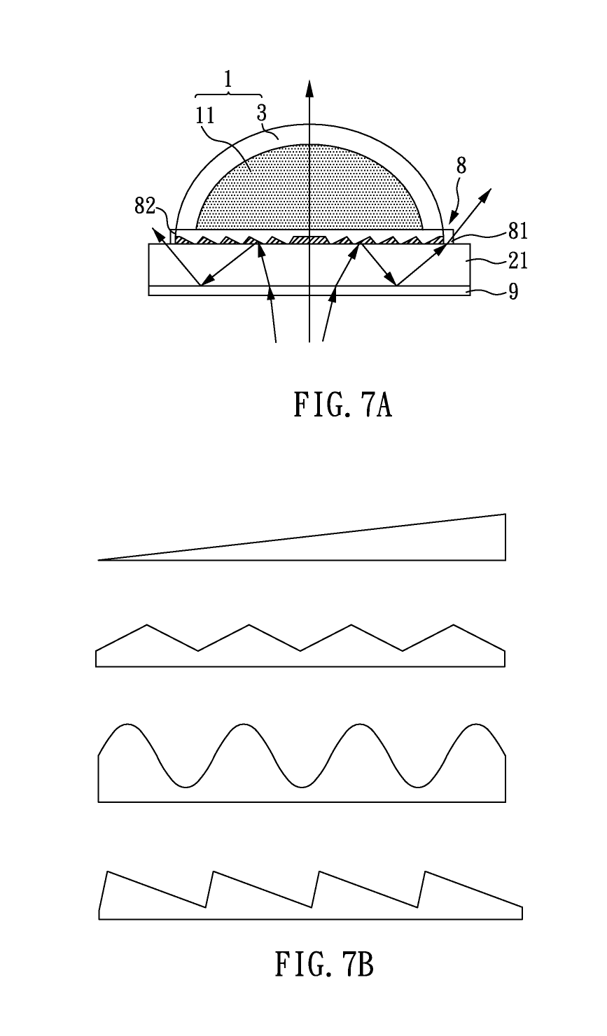

FIG. 7A shows a schematic diagram of the protruding electrode layer with the micro-reflection layer. A protruding part 11 is formed on the glass substrate 21 with the organic materials, such as fluorinated ethylene propylene copolymer: perfluoro ethylene propylene copolymer, poly(perfluoro ethylene propylene); or tetrafluoroethylene-perfluoroalkoxy vinyl ether copolymer, and then an ITO is coated thereon to serve as an electrode layer 3. In this case, the cross-sectional shape of the protruding electrode layer 1 is semicircular (but the present invention is not limited thereto, the cross-sectional shape may also be of other shapes such as the semi-elliptical shape). In addition, a micro-reflection layer 8 is further disposed between the protruding electrode layer 1 and the glass substrate 21, and a high refractive index layer 9 is disposed on the glass substrate 21 corresponding to the micro-reflection layer 8, wherein the micro-reflection layer 8 includes the symmetric micro-reflection units 81, 82. Herein, the light path is indicated by the arrowhead: the light corresponding to the center of the protruding electrode layer 1 may be directly emitted, while the light corresponding to the edge of the protruding electrode layer 1 may be reflected to the high refractive index layer 9 by the micro-reflection layer 8 and totally reflected again, thereby reducing the light leakage and recovering the light to increase the transmittance. In addition, the structures of the micro-reflection layer 8 may be exemplary as illustrated in FIG. 7B.

It should be understood that these examples are merely illustrative of the present invention and the scope of the invention should not be construed to be defined thereby, and the scope of the present invention will be limited only by the appended claims.

1. A liquid crystal display panel, comprising:
a first substrate;
a second substrate opposite to the first substrate;
an optically isotropic liquid crystal layer disposed between the first substrate and the second substrate; and
a protruding electrode layer composed of a polymer conductive material and disposed on the first substrate.

2. The liquid crystal display panel of claim 1, wherein the polymer conductive material is selected from the group consisting of polyaniline, polypyrrole, polyacetylene, polythiophen, and poly(3,4-ethylenedioxythiophene)/poly(styrenesulfonate) (PEDOT/PSS).

3. The liquid crystal display panel of claim 1, wherein a difference in refractive indexes between the polymer conductive material and the blue phase liquid crystal layer is less than 0.5.

4. The liquid crystal display panel of claim 1, wherein the optically isotropic liquid crystal layer is a blue phase liquid crystal layer.

5. A liquid crystal display panel, comprising:
a first substrate;
a second substrate opposite to the first substrate;
an optically isotropic liquid crystal layer disposed between the first substrate and the second substrate;
a protruding electrode layer disposed on the first substrate, which comprises a protruding part and an electrode layer, wherein the electrode layer is disposed on the protruding part; and
a light leakage-proof unit disposed between the protruding electrode layer and the first substrate, wherein the light leakage-proof unit is selected from the group consisting of a submicron structure layer, a multilayer film, and a micro-reflection layer.

6. The liquid crystal display panel of claim 5, wherein the light leakage-proof unit is the submicron structure layer comprising a plurality of submicron structures.

7. The liquid crystal display panel of claim 6, wherein a cross-sectional shape of the plurality of submicron structures is selected from the group consisting of rectangle, trapezoid, triangle, and polygon.

8. The liquid crystal display panel of claim 6, wherein a density of the plurality of submicron structures is directly proportional to an absolute value of an inclined plane slope of the protruding electrode layer.

9. The liquid crystal display panel of claim 6, wherein the submicron structure layer has an opening corresponding to an area of the protruding electrode layer, and an absolute value of an inclined plane slope of the area is 0 to 0.15.

10. The liquid crystal display panel of claim 5, wherein the light leakage-proof unit is the multilayer film.

11. The liquid crystal display panel of claim 10, wherein the multilayer film has an opening corresponding to an area of the protruding electrode layer, and an absolute value of an inclined plane slope of the area is 0 to 0.15.

12. The liquid crystal display panel of claim 5, wherein the light leakage-proof unit is the micro-reflection layer.

13. The liquid crystal display panel of claim 12, further comprising a high refractive index layer disposed on the first substrate and corresponding to the micro-reflection layer.

14. The liquid crystal display panel of claim 12, wherein the micro-reflection layer has an opening corresponding to an area of the protruding electrode layer, and an absolute value of an inclined plane slope of the area is 0 to 0.15.

15. The liquid crystal display panel of claim 5, wherein the optically isotropic liquid crystal layer is a blue phase liquid crystal layer.
